(19) United States
(12) Patent Application Publication
(10) Pub. No.: US 2013/0153549 A1
(43) Pub. Date: Jun. 20, 2013

(54) APPARATUS AND METHOD FOR MANUFACTURING A SWING-RING PLATE

(71) Applicant: Si Hwa Lee, Jinju-si (KR)

(72) Inventor: Si Hwa Lee, Jinju-si (KR)

(73) Assignee: HANARO TECH CO., LTD, Changwon-si, Gyeongsangnam-do (KR)

(21) Appl. No.: 13/819,646

(22) PCT Filed: Jun. 29, 2011
(86) PCT No.: PCT/KR2011/004727

§ 371 Date: Feb. 27, 2013

(30) Foreign Application Priority Data
Aug. 27, 2010 (KR) 10-2010-0083516

(51) Int. Cl. B23K 31/02; B23K 9/00; B23K 26/00; B23K 37/00

(52) U.S. Cl. CPC B23K 31/02; B23K 37/00; B23K 9/00; B23K 26/00
USPC 219/121.63; 228/17.5; 228/17; 228/9; 228/173.1; 228/102; 219/121.11

(57) ABSTRACT

Disclosed is an apparatus and method for manufacturing a swing-ring plate. More particularly, the apparatus and method for manufacturing the swing-ring plate comprises a bending mechanism that moves a linear plate cut to a certain length from a first side to a second side, and bends the linear plate so as to face both ends thereof each other to form a ring shape; a pre-bonding mechanism that fixes the bent plate in the ring shape and pre-bonds the ends in the horizontal and vertical directions; and a final bonding mechanism that completely bonds the pre-bonded part of the plate by revolving around the fixed pre-bonded plate and positioning so that the top and bottom surfaces of the pre-bonded plate face upward. According to the present invention, due to the fact that the swing-ring plate can be manufactured by bending a single plate, the traditional task of adjusting the smoothness of each part can be reduced, reducing work time and costs, and particularly, due to the lack of wasting raw materials, as occurs in the traditional processing of a unit plate that carries a certain curvature from a limited area, manufacturing costs can be further reduced, and smoothness can be readily adjusted to improve product reliability.

### FIELD OF THE INVENTION

The present invention relates to an apparatus and method for manufacturing a swing-ring plate, and more particularly, to an apparatus and method for manufacturing a swing-ring plate which bends a single linear plate into a ring-shaped plate, pre-bonds the folded end part of the ring-shaped plate and then completely bonds the pre-bonded part of the plate to thereby reduce work processes, work time and costs, and easily adjust smoothness to improve product reliability.

### BACKGROUND ART

Generally, heavy equipment for construction such as excavators includes a rotating body provided on a wheeled body operating on an endless track, and a rotated body such as a driver seat connected to the rotating body so that the driver seat of the excavator rotates and moves to the left and right sides.

The rotating body must include a swing-ring plate, which supports the rotating body when the rotated body such as the driver seat of the excavator is rotated. The swing-ring plate is welded and fixed to an upper part of a cylindrical body that is fixed to a central part of a supporting body covering and supporting the upper part of the wheeled body forming the trace of the endless track.

The upper part of the swing-ring plate is connected to a rotating driver including a ring gear, and the rotating driver is connected to the rotated body of the heavy equipment for construction such as the excavator.

As shown in FIG. 1, a band-shaped plate which contacts a lower part of a ring gear 1 forming the lower end of the rotating driver is a swing-ring plate 2 as referred to herein.

Such swing-ring plate 2 is obtained by cutting and processing a plate member 2b through CNC processing, etc. and manufacturing a unit plate 2a in a circular arc shape.

The respective unit plates 2a are ground and processed, and the end parts of the respective unit plates 2a are welded to manufacture the swing-ring plate 2 in the circular arc shape.

Accordingly, to perform the aforementioned processes, the plate member 2b is cut and processed through CNC processing with a predetermined curvature, causing significant waste of materials.

Also, the cut and processed unit plates 2a should be welded and thus significant processing time is required to perform the CNC processing and cutting operation and welding operation.

The reference numeral A means a welded portion.

The swing-ring plate which is obtained by welding a plurality of welding points should ensure good smoothness by accurate welding. However, such smoothness depends on the skill of operators during the manufacturing process, decreasing product reliability.

Further, the swing-ring plate in a precise circular shape may be implemented by using the unit plates with the same curvature, but depending on the skill of operators, the curvature and length of unit plates may vary. Thus, it is difficult to implement the swing-ring plate in the accurate circular shape during the welding process.

This necessarily accompanies a post-processing such as repeated CNC processing and cutting operations, sharply increasing work time and decreasing productivity.

The aforementioned bending technology is from time to time used to bend small parts having a small diameter, but rarely used to bend large parts such as the swing-ring plate of large construction equipment such as construction machinery. In particular, the plate which is thick in thickness, compared to the width thereof, is not bent.

### DISCLOSURE OF INVENTION

The present invention is conceived to solve the above-described problems, an aspect of which is to provide an apparatus and a method for manufacturing a swing-ring plate which includes a bending mechanism that bends a single linear plate into a ring shape, a pre-bonding mechanism that pre-bonds the opposite ends of the bent plate and a final bonding mechanism which completely bonds the pre-bonded part of the plate.

Further, another aspect of the present invention is to provide an apparatus and a method for manufacturing a swing-ring plate which enables the final bonding mechanism to sequentially completely bond the surface of the pre-bonded opposite ends of the plate to improve the connection force thereof and product quality.

Also, a third aspect of the present invention is to provide an apparatus and a method for manufacturing a swing-ring plate which further includes a smoothness adjusting mechanism and an inspection mechanism between the bending mechanism and the pre-bonding mechanism to easily adjust smoothness and improve product reliability by repeating the smoothness adjustment and inspection with respect to the bent plate in the ring shape.

The foregoing and/or other aspects of the present invention are achieved by providing an apparatus for manufacturing a swing-ring plate comprising: a bending mechanism which moves a linear plate cut to a certain length from a first side to a second side, and bends the linear plate so as to face opposite ends thereof each other to form a ring shape; a pre-bonding mechanism which fixes the bent plate having the ring shape in horizontal and vertical directions and pre-bonds the ends of the plate; and a final bonding mechanism which bonds the pre-bonded part of the plate by revolving the fixed pre-bonded plate with respect to a center thereof so that top and bottom surfaces of the pre-bonded plate are selectively positioned facing upward.

The bending mechanism comprises a fixing roller which is rotatably provided and has a fixing bending groove formed along an external circumference; a body which is provided with the fixing roller on a top thereof with respect to a front surface, and has downwardly inclined guide grooves to be symmetrical with respect to a vertical extended line passing through a center of the fixing roller; a pair of elevating rollers which are movable along the respective guide grooves of the body, respectively have elevating bending grooves formed in external circumferences corresponding to the fixing bending groove, and rotate together with the fixing roller so as to bend the linear plate; and an elevating cylinder which elevates at least one of the pair of elevating rollers, wherein if the plate is moved along the fixing bending groove of the fixing roller and the elevating bending groove of each elevating cylinder, the at least one elevating roller is elevated by the elevating cylinder and presses the plate toward the fixing roller to bend the plate in a ring shape.

The pre-bonding mechanism comprises a base frame; a pair of stoppers which are provided on a top surface of the base frame, between which both ends of the ring-shaped plate are located, and which respectively comprise seating grooves to stably seat an external surface of the ring-shaped plate therein; a plurality of holders which hold an upside of the ring-shaped plate and prevent the plate from being separated upward, by a plurality of holding pieces which rotate and are provided in the base frame to be located inside the ring-shaped plate stably seated in the stoppers; a horizontal fixing part which presses the held plate in a direction toward a middle between the pair of stoppers and horizontally fixes the plate together with the stoppers; and a vertical fixing part which downwardly presses both ends of the plate fixed by the horizontal fixing part to fix the folded ends of the plate in a vertical direction, wherein the ends of the fixed ring-shaped plate is pre-bonded by the pre-bonding mechanism.

The apparatus further comprises a pair of auxiliary fixing parts provided on the other top sides of the base frame, and assists the horizontal fixing part by pressing and fixing the plate toward the vertical fixing part.

The pre-bonding mechanism may be pre-bonded through one selected among gas welding, arc welding, resistance welding, laser welding and ultrasonic welding.

The final bonding mechanism may comprise a pair of base frames which are spaced from each other at a predetermined interval; a bearing which is provided on the top of each base frame; a first rotating frame of which opposite ends are rotatably provided in the respective bearings and which rotates based on a central axis; a second rotating frame which is provided in a central part of the first rotating frame so as to support and rotate the pre-bonded plate in the horizontal direction along the surface of the first rotating frame; a plurality of fixing pieces which is provided in the second rotating frame and fixes the plate; and a rotating driver which is provided in each bearing and rotates the first rotating frame, wherein the first and second rotating frames to which the pre-bonded plate is fixed are rotated to completely bond the pre-bonded part of the plate.

The final bonding mechanism completely bonds the plate through one selected among gas welding, arc welding, resistance welding, laser welding and ultrasonic welding.

The apparatus further comprises a smoothness adjusting mechanism which is provided between the bending mechanism and the pre-bonding mechanism and adjusts a smoothness of the plate bent in the ring shape; and an inspection mechanism which is provided between the bending mechanism and the pre-bonding mechanism and inspects the smoothness of the ring-shaped plate, wherein the smoothness adjusting mechanism and the inspection mechanism repeat their respective operations until the ring-shaped plate meets a certain smoothness.

The smoothness adjusting mechanism may comprise a smoothness body which has a smoothness space formed on a top central part thereof and locates the ring-shaped plate in the smoothness space; a smoothness supporter which has a flat surface, is located in a lateral wall of the smoothness space and contacts one surface of the ring-shaped plate; a smoothness hitter which corresponds to the smoothness supporter, and contacts the other surface of the ring-shaped plate; and a smoothness presser which is provided on the other surface of the smoothness space of the smoothness body, and moves the smoothness hitter toward the smoothness supporter, wherein the smoothness presser adjusts the smoothness of the ring-shaped plate together with the smoothness supporter.

The apparatus may further comprise an edge bending mechanism which bends one end of the linear plate to bend the linear plate smoothly.

Before the linear plate is moved to the bending mechanism, the ends of the linear plate have central parts protruding to linearly contact each other after the bending operation.

Before the plate is moved to the bending mechanism, the ends of the plate are inclinedly formed to surface-contact each other after the bending operation, from a plane view.

The foregoing and/or other aspects of the present invention are achieved by providing a method for manufacturing a swing-ring plate comprising: inserting a linear plate between a single fixing roller and a pair of elevating rollers which are provided below the fixing roller and are elevated toward a rotational center of the fixing roller by respective elevating cylinders; bending the linear plate, inserted by the respective elevating rollers elevated by the respective elevating cylinders, in a ring shape, so that opposite ends of the linear plate face each other; firstly fixing the plate in horizontal and vertical directions to locate both ends of the bent ring-shaped plate in one side; pre-bonding a predetermined part of both ends of the fixed plate; secondly fixing the plate, both ends of which are pre-bonded, by revolving the fixed pre-bonded plated with respect to a center thereof so that top and bottom surfaces of the pre-bonded plate are selectively positioned facing upward; and rotating the plate fixed at the second fixing operation to sequentially locate the top surface or the bottom surface of the pre-bonded ends of the plate and completely bonding the pre-bonded ends of the plate.

The bending comprises firstly bending the linear plate by pressing the linear plate, which is inserted by the elevation of the elevating rollers and one elevating cylinder positioned in a direction where the linear plate is inserted, toward the fixing roller; and secondly bending the firstly-bent plate by the elevation of the elevating rollers and the other elevating cylinder, in which the firstly-bent plate is more pressed toward the fixing roller by the other elevating roller than the one elevating roller, wherein the firstly bending and secondly bending are repeated until the ends of the linear plate contact each other and form a ring shape.

The firstly fixing comprises stably seating the plate in a seating groove so that the ends of the ring-shaped plate are located between a pair of stoppers which have the seating grooves and are provided on a top surface of the base frame; holding an upside of the ring-shaped plate stably seated in the stoppers and preventing the plate from being separated upward by a plurality of holders comprising rotating holding pieces; horizontally fixing the plate by pressing the ring-shaped plate stably seated in the stoppers from the inside thereof toward the stoppers; and vertically fixing the horizontally-fixed ring-shaped plate by pressing the plate from upside to down.

The secondly fixing comprises supporting the pre-bonded plate by a second rotating frame provided in a center of a first rotating frame to rotate in the horizontal direction along the surface of the first rotating frame, wherein the first rotating frame is rotated with respect to a central axis by bearings provided on top surfaces of a pair of base frames spaced from each other at a consistent interval; and fixing an upside of the plate by a plurality of fixing pieces respectively provided in the ends of the second rotating frame.

The completely bonding comprises firstly rotating the plate by providing the first rotating frame being rotated with respect to a central axis by the bearings provided on the top surface of the pair of base frames spaced from each other at a consistent interval, supporting the pre-bonded plate by a second rotating frame provided in a center of a first rotating frame to rotate in the horizontal direction along the surface of the first rotating frame, and rotating the second rotating frame while an upside of the plate is fixed by a plurality of fixing pieces provided in the end of the second rotating frame to position the pre-bonded ends of the plate in a certain location; firstly completely bonding the top surface of the pre-bonded ends of the plate located in the certain location; secondly rotating the plate by rotating the first rotating frame to upwardly locate the bottom surface of the plate whose top surface is completely bonded, and rotating the second rotating frame to locate the bottom surface of the ends of the plate in a certain location; and secondly completely bonding the bottom surface of the plate located in the certain location.

The pre-bonding and completely bonding comprises bonding the plate through one selected among gas welding, arc welding, resistance welding, laser welding and ultrasonic welding.

The method further comprising between the bending and the firstly fixing, adjusting the smoothness of the bent ring-shaped plate; and inspecting the smoothness of the ring-shaped plate, wherein the adjusting and inspecting are repeated until the ring-shaped plate meets a certain smoothness.

### BRIEF DESCRIPTION OF THE DRAWINGS

FIG. 1 illustrates a conventional rotating driver;

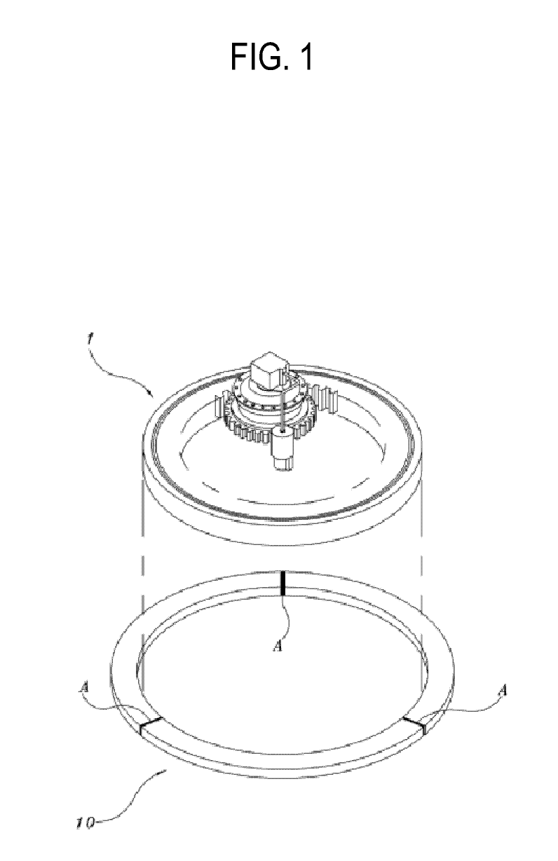

FIG. 2 illustrates a manufacturing mode of a swing-ring plate of the conventional rotating driver;

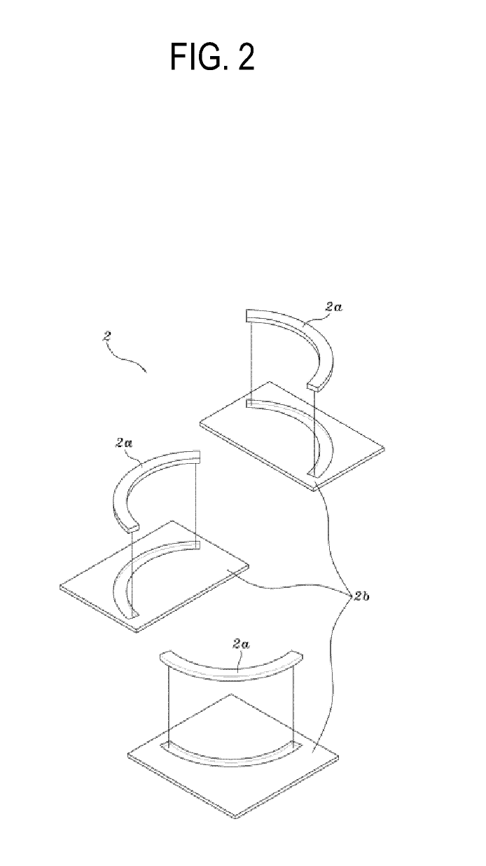

FIG. 3 illustrates an apparatus for manufacturing a swing-ring plate according to the present invention;

FIG. 4 illustrates a bending mechanism of the apparatus for manufacturing the swing-ring plate according to the present invention;

FIG. 5 is a lateral view of the bending mechanism of the apparatus for manufacturing the swing-ring plate according to the present invention;

FIG. 6 illustrates a pre-bonding mechanism of the apparatus for manufacturing the swing-ring plate according to the present invention;

FIG. 7 is a lateral view of the pre-bonding mechanism of the apparatus for manufacturing the swing-ring plate according to the present invention;

FIG. 8 is a perspective view of a final bonding mechanism of the apparatus for manufacturing the swing-ring plate according to the present invention;

FIG. 9 illustrates the final bonding mechanism of the apparatus for manufacturing the swing-ring plate according to the present invention;

FIG. 10 illustrates an installation state of a smoothness adjusting mechanism and an inspection mechanism of the apparatus for manufacturing the swing-ring plate according to the present invention;

FIG. 11 illustrates the smoothness adjusting mechanism of the apparatus for manufacturing the swing-ring plate according to the present invention;

FIG. 12 illustrates an edge bending mechanism of the apparatus for manufacturing the swing-ring plate according to the present invention;

FIG. 13 illustrates ends of a plate of the apparatus for manufacturing a swing-ring plate according to an embodiment of the present invention;

FIG. 14 illustrates ends of a plate of the apparatus for manufacturing a swing-ring plate according to another embodiment of the present invention;

FIG. 15 illustrates a method for manufacturing a swing-ring plate according to the present invention;

FIG. 16 illustrates a bending process of the method for manufacturing the swing-ring plate according to the present invention;

FIG. 17 is a flowchart of a first fixing operation of the method for manufacturing the swing-ring plate according to the present invention;

FIG. 18 illustrates the first fixing operation of the method for manufacturing the swing-ring plate according to the present invention;

FIG. 19 is a flowchart of a final bonding operation of the method for manufacturing the swing-ring plate according to the present invention; and

FIG. 20 illustrates the final bonding operation of the method for manufacturing the swing-ring plate according to the present invention.

### REFERENCE NUMERALS OF DRAWINGS

10: apparatus for manufacturing a swing-ring plate

100: bending mechanism

110: fixing roller

120: body

130 elevating roller

140: elevating cylinder

200: pre-bonding mechanism

210: base frame

220: stoppers

230: holders

240: horizontal fixing part

250: vertical fixing part

260: auxiliary fixing part

300: final bonding mechanism

310: base frame

320: bearings

330: first rotating frame

340: second rotating frame

350: fixing pieces

360: rotating driver

400: smoothness adjusting mechanism

410: smoothness body

420: smoothness supporter

430: smoothness hitter

440: smoothness presser

500: inspection mechanism

600: edge bending mechanism

### MODES FOR CARRYING OUT THE INVENTION

Hereinafter, exemplary embodiments of the present invention will be described in more detail with reference to accompanying drawings.

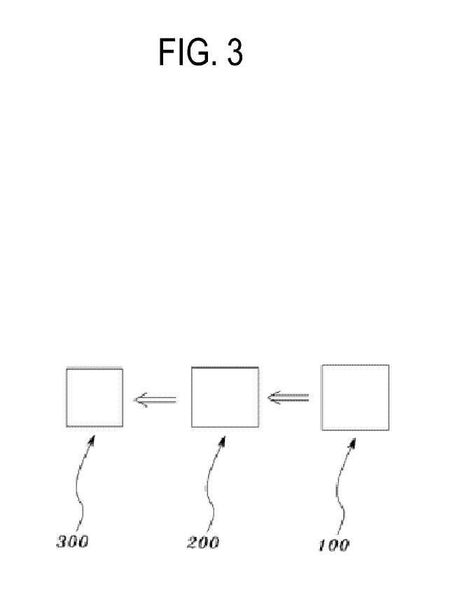

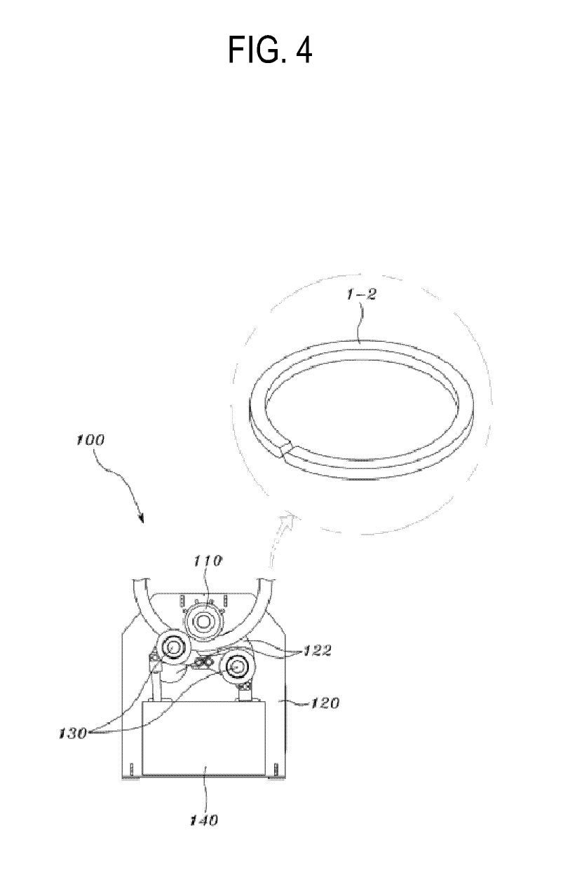

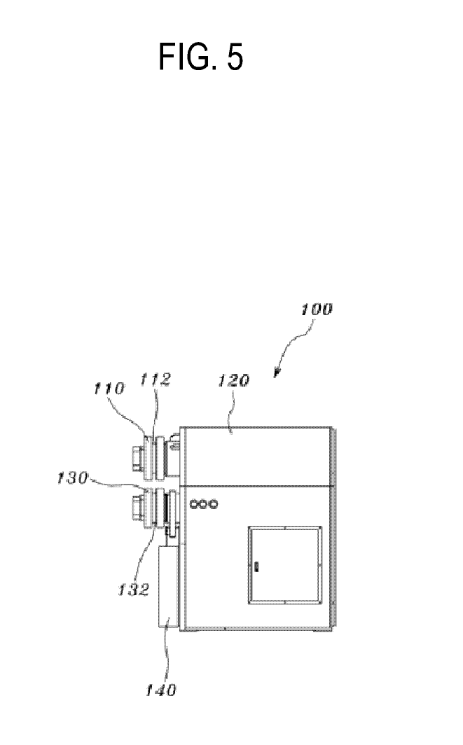

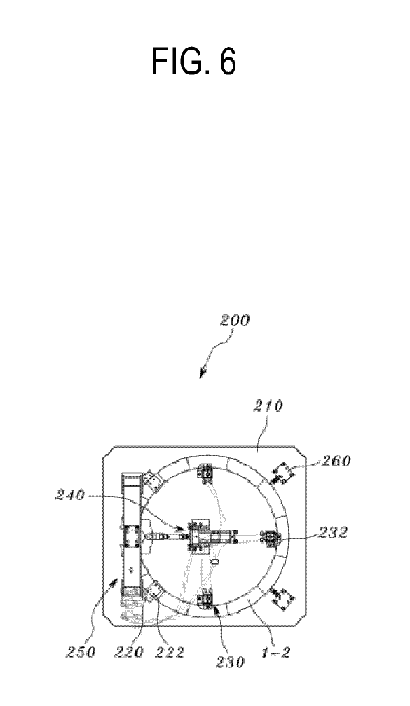

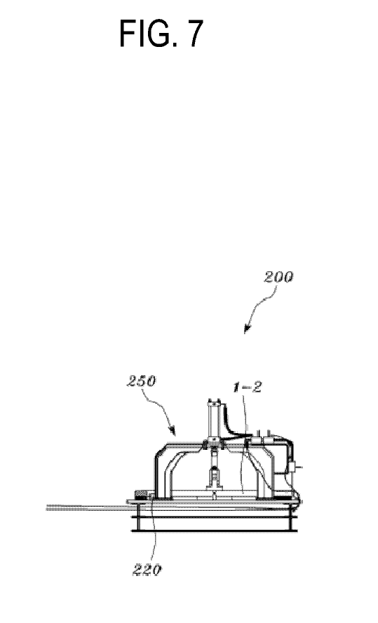

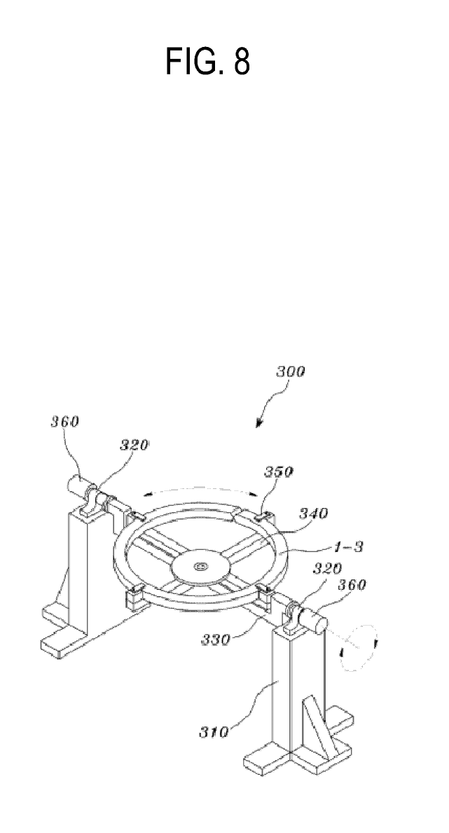

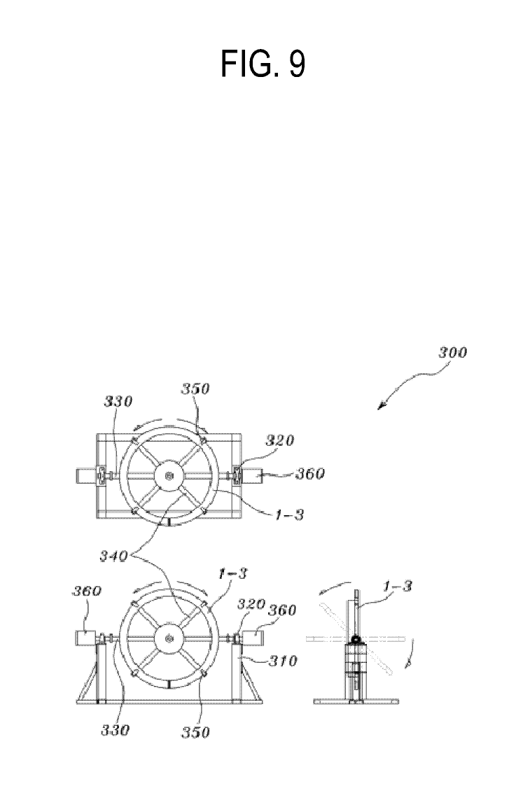

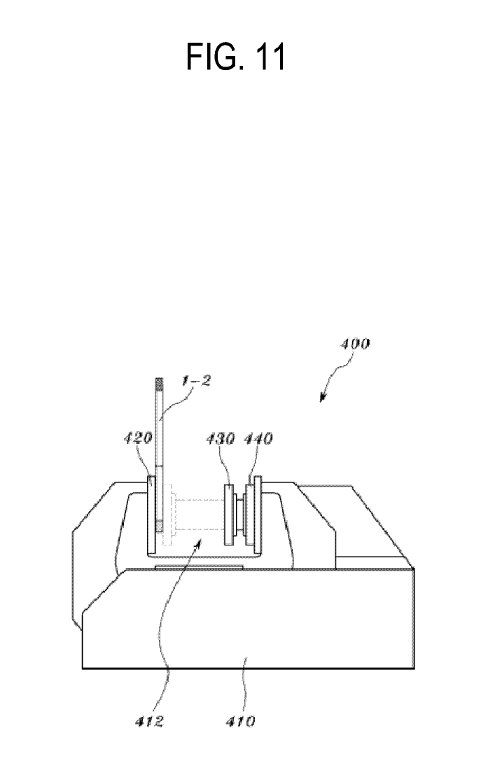

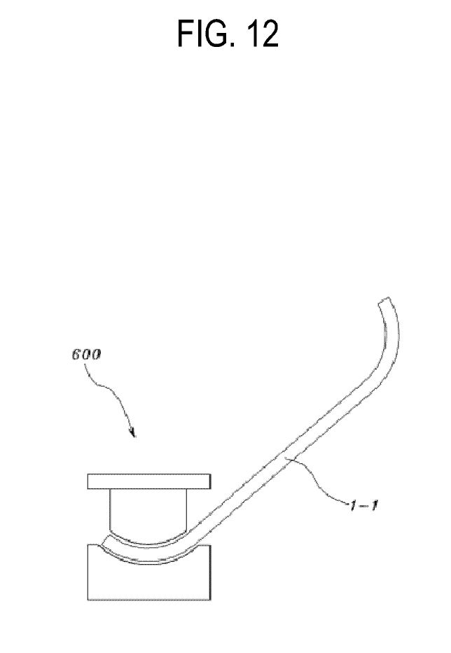

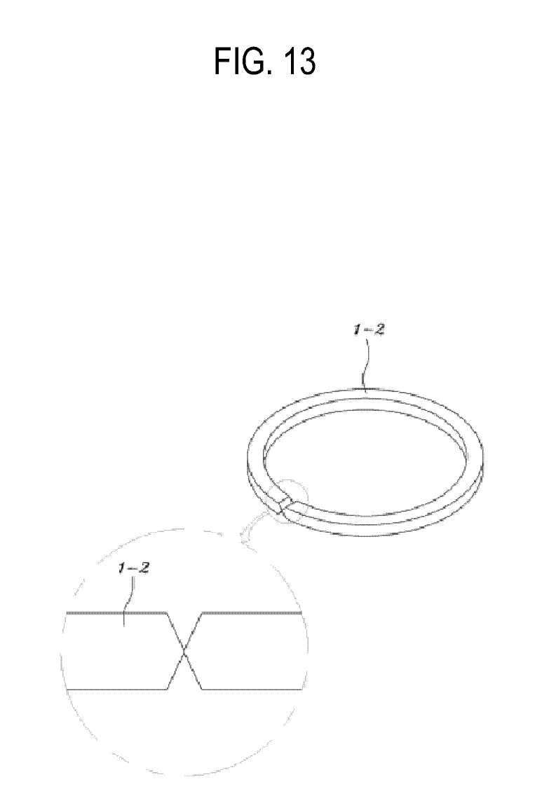

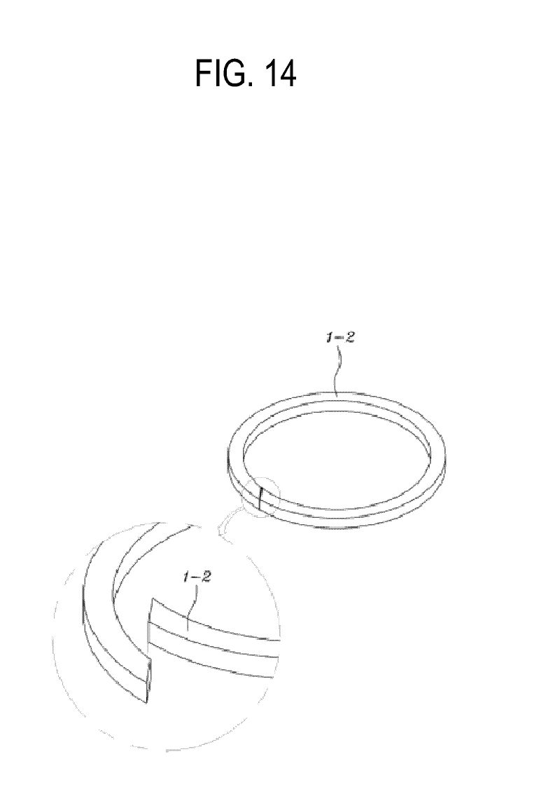

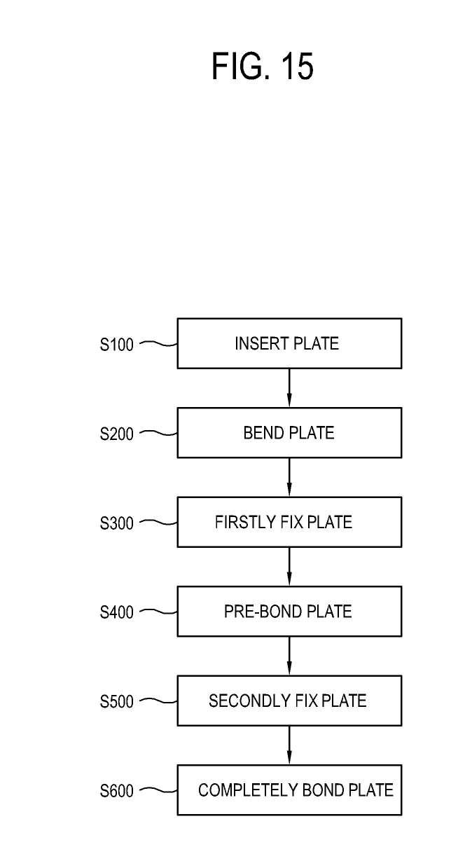

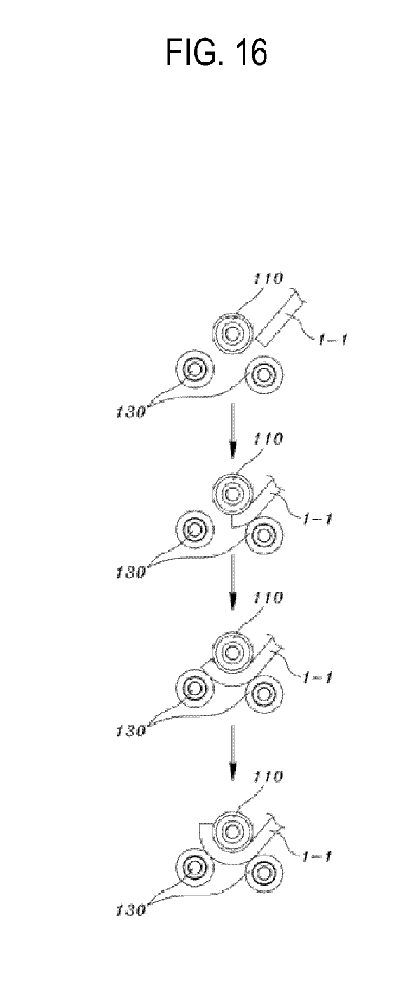

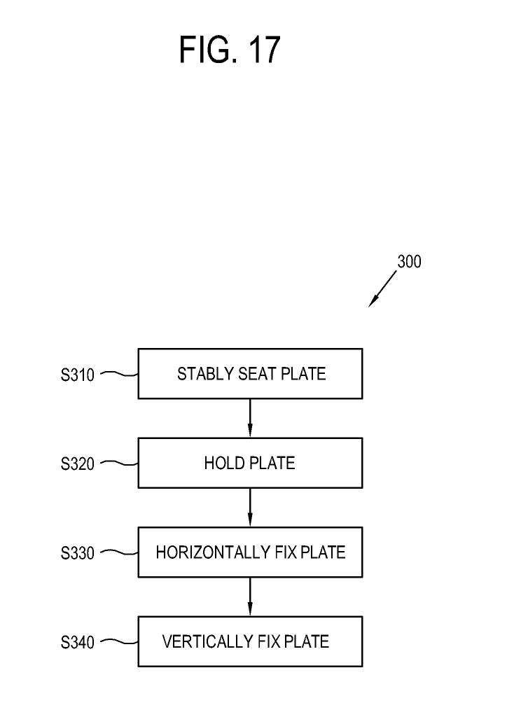

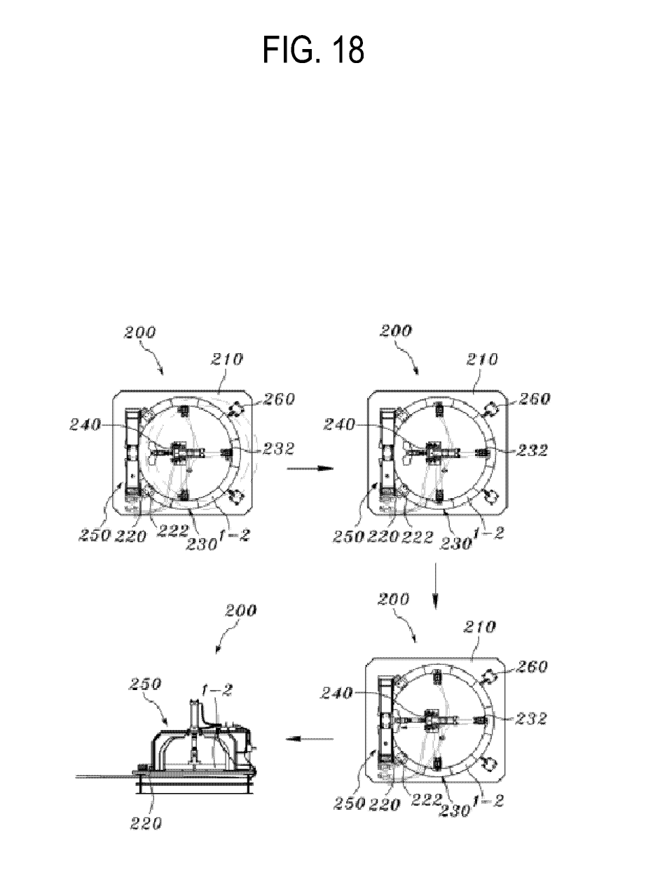

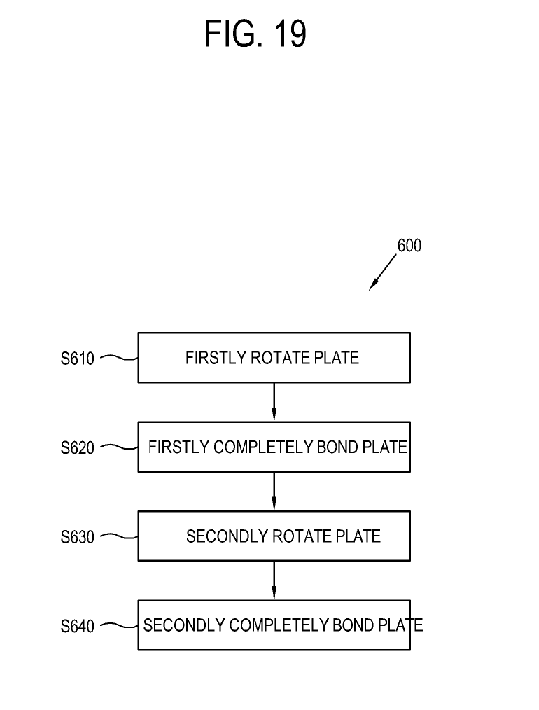

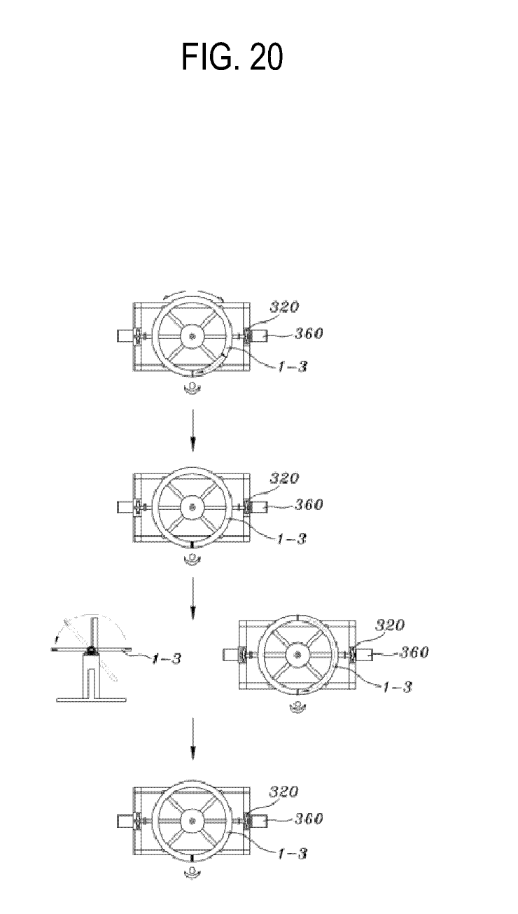

FIG. 3 illustrates an apparatus for manufacturing a swing-ring plate according to the present invention. FIG. 4 illustrates a bending mechanism of the apparatus for manufacturing the swing-ring plate according to the present invention. FIG. 5 is a lateral view of the bending mechanism of the apparatus for manufacturing the swing-ring plate according to the present invention. FIG. 6 illustrates a pre-bonding mechanism of the apparatus for manufacturing the swing-ring plate according to the present invention. FIG. 7 is a lateral view of the pre-bonding mechanism of the apparatus for manufacturing the swing-ring plate according to the present invention. FIG. 8 is a perspective view of a final bonding mechanism of the apparatus for manufacturing the swing-ring plate according to the present invention. FIG. 9 illustrates the final bonding mechanism of the apparatus for manufacturing the swing-ring plate according to the present invention. FIG. illustrates an installation state of a smoothness adjusting mechanism and an inspection mechanism of the apparatus for manufacturing the swing-ring plate according to the present invention. FIG. 11 illustrates the smoothness adjusting mechanism of the apparatus for manufacturing the swing-ring plate according to the present invention. FIG. 12 illustrates an edge bending mechanism of the apparatus for manufacturing the swing-ring plate according to the present invention. FIG. 13 illustrates ends of the plate of the apparatus for manufacturing the swing-ring plate according to an embodiment of the present invention. FIG. 14 illustrates ends of a plate of an apparatus for manufacturing a swing-ring plate according to another embodiment of the present invention. FIG. 15 illustrates a method for manufacturing a swing-ring plate according to the present invention. FIG. 16 illustrates a bending operation of the method for manufacturing the swing-ring plate according to the present invention. FIG. 17 is a flowchart of a first fixing operation of the method for manufacturing the swing-ring plate according to the present invention. FIG. 18 illustrates the first fixing operation of the method for manufacturing the swing-ring plate according to the present invention. FIG. 19 is a flowchart of a final bonding operation of the method for manufacturing the swing-ring plate according to the present invention. FIG. 20 illustrates the final bonding operation of the method for manufacturing the swing-ring plate according to the present invention.

As shown in FIG. 3, an apparatus for manufacturing a swing-ring plate 10 includes a bending mechanism 100, a pre-bonding mechanism 200 and a final bonding mechanism 300.

The bending mechanism 100 moves a linear plate 1-1 cut to a certain length from a first side to a second side, and bends the linear plate 1-1 to face both ends thereof each other to form a ring shape.

That is, the bending mechanism 100 bends the linear plate 1-1 to locate the both ends thereof at the same arc, and bends the linear plate 1-1 to allow the both ends thereof to contact each other.

The pre-bonding mechanism 200 fixes the plate 1-2 that has been bent in the ring shape by the bending mechanism 100, and then pre-bonds the ends of the plate 1-2.

The pre-bonding mechanism 200 fixes the bent plate 1-2 in the horizontal and vertical directions, and more specifically, fixes the ends of the bent plate 1-2 in the horizontal and vertical directions and pre-bonds the ends thereof.

Of course, the fixed plate 1-2 is pre-bonded by an operator or an additional bonding machine (not shown).

The final bonding mechanism 300 fixes the pre-bonded plate 1-3 and completely bonds the ends of the plate 1-3. That is, the final bonding mechanism 300 fixes the pre-bonded plate 1-3, and completely bonds the ends of the plate 1-3 by revolving around the fixed pre-bonded plate and positioning so that the top and bottom surfaces of the pre-bonded plate face upward.

Accordingly, the pre-bonded ends of the plate 1-3 are completely bonded to manufacture a swing-ring plate 1-4.

As shown in FIGS. 4 and 5, the bending mechanism 100 includes a fixing roller 110, a body 120, elevating rollers 130 and an elevating cylinder 140.

The fixing roller 110 has a fixing bending groove 112 formed along an external circumference thereof to rotate. The body 120 has the fixing roller 110 formed on a top thereof toward the front surface, and has a downwardly inclined guide groove 122 to be symmetrical based on a vertical extended line of the fixing roller 110.

The elevating rollers 130 are provided in each guide groove 122 of the body 120 and move along the guide groove 122.

The elevating rollers 130 have an elevating bending groove 132 formed in a circumference thereof corresponding to the fixing bending groove 112 of the fixing roller 110. The respective elevating bending grooves 132 rotate together with the fixing bending groove 112 to bend the linear plate 1-1.

The elevating cylinder 140 elevates at least one of a pair of elevating rollers 130, and elevates at least one of the elevating rollers 130 to bend the linear plate 1-1 together with the fixing bending groove 112.

The pair of elevating rollers 130 is elevated by the elevating cylinder 140 along the guide groove 122 of the body 120. The guide groove 122 guides the pair of elevating rollers 130 toward the fixing roller 110.

Accordingly, if the plate 1-1 is moved along the fixing bending groove 112 of the fixing roller 110 and the elevating bending groove 132 of the elevating rollers 130, the plate 1-1 is bent into the ring shape by the movement of the elevating rollers 130 toward the fixing roller 110.

As shown in FIGS. 6 and 7, the pre-bonding mechanism 200 includes a base frame 210, stoppers 220, holders 230, a horizontal fixing part 240 and a vertical fixing part 250.

A pair of stoppers 220 is provided on a top surface of the base frame 210, and the opposite ends of the ring-shaped plate 1-2 are provided between the pair of stoppers 220, and a seating groove 222 is formed in the stoppers 220 to stably seat a lateral surface of the ring-shaped plate 1-2.

The holders 230 are plurally provided in the base frame 210 to be positioned inside the ring-shaped plate 1-2 stably seated in the stoppers 220, and holds the top surface of the ring-shaped plate 1-2 stably seated in the seating groove 222 of the stoppers 220.

That is, each holder 230 includes revolving holding pieces 232. After the ring-shaped plate 1-2 is held, the holding pieces 232 revolve to be positioned on the top of the ring-shaped plate 1-2 and prevent the plate 1-2 from being separated therefrom.

The horizontal fixing part 240 presses the held plate 1-2 toward the pair of stoppers 220 and horizontally fixes the plate 1-2 together with the stoppers 220. The vertical fixing part 250 downwardly presses the end parts of the plate 1-2 fixed by the horizontal fixing part 240 to fix the folded end parts of the plate 1-2 in the vertical direction.

The horizontal fixing part 240 and the vertical fixing part 250 include cylinders to fix the held plate 1-2 in the horizontal and vertical directions.

If the ring-shaped plate 1-2 is fixed by the stoppers 220, the holders 230, the horizontal fixing part 240 and the vertical fixing part 250, the ends of the plate 1-2 is pre-bonded by a pre-welding mechanism (not shown).

Such pre-welding process may be automatically performed through an additional automatic bonding machine or by an operator through welding equipment.

The pre-bonding mechanism 200 pre-bonds the ring-shaped plate 1-2 through one of gas welding, arc welding, resistance welding, laser welding and ultrasonic welding.

The pre-bonding mechanism 200 further includes an auxiliary fixing part 260, which is provided in pairs on a top surface of the base frame 210 and presses and fixes the plate 1-2 toward the vertical fixing part 250.

Accordingly, the ring-shaped plate 1-2 is firmed fixed by the horizontal fixing part 240 and the auxiliary fixing part 260 in the horizontal direction.

As shown in FIGS. 8 and 9, the final bonding mechanism 300 includes base frames 310, a bearing 320, a first rotating frame 330, a second rotating frame 340, a fixing piece 350 and a rotating driver 360.

The base frames 310 are provided in pairs, and spaced from each other at a consistent interval, and the bearing 320 is provided on a top surface of the base frames 310.

The first rotating frame 330 is provided in the bearing 320 so as to rotate at their ends, and rotates based on the central axis of the bearing 320.

The second rotating frame 340 is provided in a central part of the first rotating frame 330 to rotate in the horizontal direction along the surface of the first rotating frame 330, and rotates upwards and downwards together with the first rotating frame 330.

The pre-bonded plate 1-3 is supported by the second rotating frame 340.

The fixing piece 350 is provided in the second rotating frame 340 and fixes the plate 1-3 to the second rotating frame 340. The rotating driver 360 is provided in the bearing 320 and rotates the first rotating frame 330.

The final bonding mechanism 300 rotates the first and second rotating frames 330 and 340 to which the pre-bonded plate 1-3 is fixed, and sequentially completely bonds the pre-bonded part of the plate 1-3.

The final bonding mechanism 300 may include a final bonding part (not shown) to completely bond the pre-bonded plate 1-3. The pre-bonded plate may be automatically completely bonded by an additional automatic bonding machine or by an operator through welding equipment.

The final bonding mechanism 300 completely bonds the pre-bonded plate 1-3 through one of gas welding, arc welding, resistance welding, laser welding and ultrasonic welding.

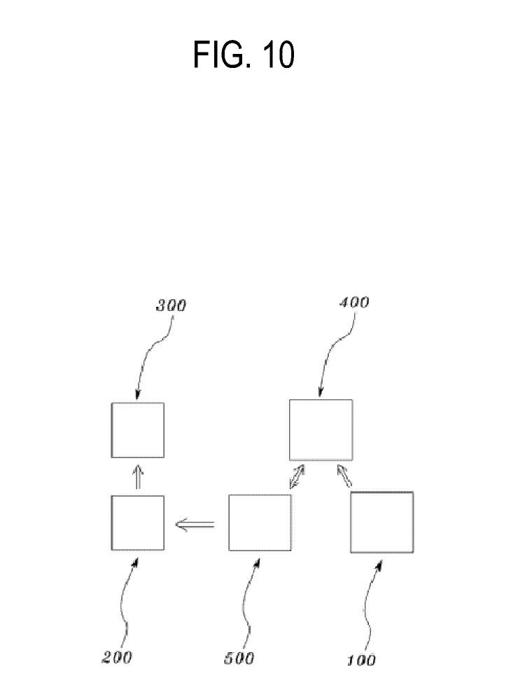

As shown in FIG. 10, a smoothness adjusting mechanism 400 and an inspection mechanism 500 are further provided between the bending mechanism 100 and the pre-bonding mechanism 200. The smoothness adjusting mechanism 400 adjusts the smoothness of the plate 1-2 bent in the ring shape by the bending mechanism 100.

The inspection mechanism 500 inspects the smoothness of the ring-shaped plate 1-2, and determines whether the plate 1-2 meets reference smoothness to be commercialized.

The smooth adjusting mechanism 400 and the inspection mechanism 500 perform their respective operations repeatedly until the ring-shaped plate 1-2 meets certain smoothness.

As shown in FIG. 11, the smoothness adjusting mechanism 400 includes a smoothness body 410, a smoothness supporter 420, a smoothness hitter 430 and a smoothness presser 440.

The smoothness body 410 has a smoothness space 412 formed on a top central part thereof, and the ring-shaped plate 1-2 is located in the smoothness space 412. The smoothness supporter 420 has a flat surface, is located in a lateral wall of the smoothness space 412 and contacts the ring-shaped plate 1-2.

The smoothness hitter 430 is provided in the smoothness body 410 corresponding to the smoothness supporter 420, and is moved to the smoothness supporter 420 by the smoothness presser 440. The smoothness hitter 430 repeatedly hits the surface of the ring-shaped plate 1-2 to adjust the smoothness of the plate 1-2.

The edge bending mechanism 600 is further provided to cut one end of the linear plate 1-1 to smoothly bend the linear plate 1-1. As shown in FIG. 12, the ends of the plate 1-2 are pre-bonded by the edge bending mechanism 600 to ensure an efficient bending operation of the bending mechanism 100.

The both ends of the linear plate 1-2 may vary before being bent. As shown in FIG. 13, the both ends of the linear plate 102 have a central part protruding in the width direction.

If the linear plate 1-2 is bent by the bending mechanism 100, the central parts of the ends contact each other linearly so that the smoothness of the bent plate may be checked by the naked eye. When the pre-bonding mechanism 200 or the final bonding mechanism 300 performs the bonding operation, more parts are bonded to improve the bonding force and ensure an efficient bonding operation.

As shown in FIG. 14, the ends of the linear plate 1-2 are inclinedly formed to linearly contact each other after the bending operation.

This enables an operator to check the circle formed by internal and external circumferences with the naked eye and check the shape of a centric circle and smoothness when the linear plate 1-2 is bent by the bending mechanism 100.

As shown in FIG. 15, a method for manufacturing the swing-ring plate includes an insertion operation S100, a bending operation S200, a first fixing operation S300, a pre-bonding operation S400, a second fixing operation S500 and a final bonding operation S600.

At the insertion operation S100, the linear plate 1-1 is inserted between the single fixing roller 110 and the pair of elevating rollers 130 which is provided below the fixing roller 110 and is elevated in the rotational central direction of the fixing roller 110 by the elevating cylinders 140.

At the bending operation S200, the linear plate 1-1 is bent into a ring by the elevating rollers 130 elevated by the elevating cylinder 140 so as to bring the ends thereof together and opposite one another in order to form a ring.

At the first fixing operation S300, the bent plate 1-2 in the ring shape is fixed in the horizontal and vertical directions so as to locate the ends thereof in one side. At the pre-bonding operation S400, the ends of the fixed plate 1-2 are pre-bonded.

At the second fixing operation S500, the plate 1-3 whose ends have been pre-bonded is fixed by revolving around its center and positioning so that the top and bottom surfaces of the plate 1-3 face upward.

The fixed pre-bonded plate 1-3 is completely bonded at the final bonding operation S600, at which the fixed plate 1-3 is rotated to position the top or bottom surface of the pre-bonded ends thereof and the plate 1-3 is completely bonded to manufacture the swing-ring plate 1-4.

The bending operation S200 includes a first bending operation S210 and a second bending operation S220 as shown in FIG. 16.

At the first bending operation S210, the linear plate 1-1 is pressed toward the fixing roller 110 by the elevation of one elevating cylinder 140 and the elevating rollers 130 provided in the direction in which the linear plate 1-1 is inserted, and bent firstly.

At the second bending operation S220, the firstly-bent plate is secondly bent by the elevation of the other elevating cylinder 140 and the elevating rollers 130. The other elevating roller 130 further presses the firstly-bent plate toward the fixing roller 110 than one elevating roller 130 does, to perform the second bending operation.

The first and second bending operations S210 and S220 are repeated until the linear plate 1-1 forms a ring shape by contacting their ends.

As shown in FIGS. 17 and 18, the first fixing operation S300 includes a seating operation S310, a holding operation S320, a horizontal fixing operation S330 and a vertical fixing operation S340.

At the seating operation S310, the plate is stably seated in the seating groove 222 so that the ends of the ring-shaped plate 1-2 are positioned between the pair of stoppers 200 provided on the top surface of the base frame 210.

At the holding operation S320, the ring-shaped plate 1-2 which is stably seated in the stoppers 200 is held upward by the plurality of holders 230 including the rotating holding piece 232. The holders 230 prevent the ring-shaped plate 1-2 from being separated upward.

At the horizontal fixing operation S330, the ring-shaped plate 1-2 which is stably seated in the stoppers 200 is pressed toward the stoppers 200 to be fixed horizontally.

At the vertical fixing operation S340, the ring-shaped plate 1-2 which is horizontally fixed is pressed downward to be vertically fixed.

At the pre-bonding operation S400, the ends of the fixed, ring-shaped plate 1-2 are pre-bonded.

The second fixing operation S500 includes a supporting operation S510 and a fixing operation S520. At the supporting operation S510, the pre-bonded plate 1-3 is supported by the second rotating frame 340.

That is, the first rotating frame 330 is provided to rotate along the central axis by the bearing 320 provided on the top surface of the pair of base frames 310 spaced at a consistent internal. The second rotating frame 340 which is provided to rotate in the horizontal direction along the surface of the first rotating frame 330 supports the pre-bonded plate 1-3.

At the fixing operation S520, the plate 1-3 is fixed upward by the plurality of fixing pieces 350 provided in the end of the second rotating frame 340 and fixed to the second rotating frame 340.

As shown in FIGS. 19 and 20, at the final bonding operation S600, the plate 1-3 fixed to the final bonding mechanism 300 is completely bonded. The final bonding operation S600 includes a first rotating operation S610, a first final bonding operation S620, a second rotating operation S630 and a second final bonding operation S640.

At the first rotating operation S610, while the plate 1-3 is fixed upward by the plurality of fixing pieces 350 provided in the end of the second rotating frame 440, the second rotating frame 440 rotates so that the pre-bonded plate is rotated to locate the ends thereof in a certain location.

At the first final bonding operation S620, the top surface of the pre-bonded ends of the plate 1-3 is completely bonded.

At the second rotating operation S630, the plate whose top surface has been completely bonded is rotated so that the bottom surface is positioned upward. After the rotation of the first rotating frame 330, the second rotating frame 340 rotates to locate the bottom surface of the ends of the plate 1-3 in a certain location.

At the second final bonding operation S640, the bottom surface of the plate 1-3 is completely bonded to manufacture the swing-ring plate 1-4.

At the pre-bonding operation S400 and the final bonding operation S600, the plate is bonded through one of gas welding, arc welding, resistance welding, laser welding and ultrasonic welding.

The smoothness adjusting operation and the inspection operation are further performed between the bending operation S200 and the first fixing operation S300 to adjust the smoothness of the bent plate in the ring shape and to inspect the smoothness of the ring-shaped plate, respectively.

The smoothness adjusting operation and the inspection operation are performed by the smoothness adjusting mechanism 400 and the inspection mechanism 500, respectively, and are performed repeatedly until the ring-shaped plate 1-2 meets certain smoothness.

Of course, the certain smoothness in the inspection operation refers to reference smoothness for commercializing the plate.

As described above, the apparatus and method for manufacturing the swing-ring plate according to the present invention may manufacture a swing-ring plate by bending a single plate, reduce work processes in adjusting smoothness of the plate, reduce work time and costs, and particularly, no raw materials are wasted as the unit plate having a certain curvature from a limited area is processed to further reduce manufacturing costs. Further, smoothness of the plate may be easily adjusted and product reliability may improve.

What is claimed is:

1. An apparatus for manufacturing a swing-ring plate comprising:
a bending mechanism which moves a linear plate cut to a certain length from a first side to a second side, and bends the linear plate so as to face opposite ends thereof each other to form a ring shape;
a pre-bonding mechanism which fixes the bent plate having the ring shape in horizontal and vertical directions and pre-bonds the ends of the plate; and
a final bonding mechanism which bonds the pre-bonded part of the plate by revolving the fixed pre-bonded plate with respect to a center thereof so that top and bottom surfaces of the pre-bonded plate are selectively positioned facing upward.

2. The apparatus according to claim 1, wherein the bending mechanism comprises a fixing roller which is rotatably provided and has a fixing bending groove formed along an external circumference;
a body which is provided with the fixing roller on a top thereof with respect to a front surface, and has downwardly inclined guide grooves to be symmetrical with respect to a vertical extended line passing through a center of the fixing roller;
a pair of elevating rollers which are movable along the respective guide grooves of the body, respectively have elevating bending grooves formed in external circumferences corresponding to the fixing bending groove, and rotate together with the fixing roller so as to bend the linear plate; and
an elevating cylinder which elevates at least one of the pair of elevating rollers,
wherein if the plate is moved along the fixing bending groove of the fixing roller and the elevating bending groove of each elevating cylinder, the at least one elevating roller is elevated by the elevating cylinder and presses the plate toward the fixing roller to bend the plate in a ring shape.

3. The apparatus according to claim 1, wherein the pre-bonding mechanism comprises
a base frame;
a pair of stoppers which are provided on a top surface of the base frame, between which both ends of the ring- shaped plate are located, and which respectively comprise seating grooves to stably seat an external surface of the ring-shaped plate therein;
a plurality of holders which hold an upside of the ring-shaped plate and prevent the plate from being separated upward, by a plurality of holding pieces which rotate and are provided in the base frame to be located inside the ring-shaped plate stably seated in the stoppers;
a horizontal fixing part which presses the held plate in a direction toward a middle between the pair of stoppers and horizontally fixes the plate together with the stoppers; and
a vertical fixing part which downwardly presses both ends of the plate fixed by the horizontal fixing part to fix the folded ends of the plate in a vertical direction,
wherein the ends of the fixed ring-shaped plate is pre-bonded by the pre-bonding mechanism.

4. The apparatus according to claim 3, further comprising a pair of auxiliary fixing parts provided on the other top sides of the base frame, and assists the horizontal fixing part by pressing and fixing the plate toward the vertical fixing part.

5. The apparatus according to claim 1, wherein the pre-bonding mechanism is pre-bonded through one selected among gas welding, arc welding, resistance welding, laser welding and ultrasonic welding.

6. The apparatus according to claim 1, wherein the final bonding mechanism comprises a pair of base frames which are spaced from each other at a predetermined interval;
a bearing which is provided on the top of each base frame;
a first rotating frame of which opposite ends are rotatably provided in the respective bearings and which rotates based on a central axis;
a second rotating frame which is provided in a central part of the first rotating frame so as to support and rotate the pre-bonded plate in the horizontal direction along the surface of the first rotating frame;
a plurality of fixing pieces which is provided in the second rotating frame and fixes the plate; and
a rotating driver which is provided in each bearing and rotates the first rotating frame,
wherein the first and second rotating frames to which the pre-bonded plate is fixed are rotated to completely bond the pre-bonded part of the plate.

7. The apparatus according to claim 6, wherein the final bonding mechanism completely bonds the plate through one selected among gas welding, arc welding, resistance welding, laser welding and ultrasonic welding.

8. The apparatus according to claim 1, further comprising
a smoothness adjusting mechanism which is provided between the bending mechanism and the pre-bonding mechanism and adjusts a smoothness of the plate bent in the ring shape; and
an inspection mechanism which is provided between the bending mechanism and the pre-bonding mechanism and inspects the smoothness of the ring-shaped plate,
wherein the smoothness adjusting mechanism and the inspection mechanism repeat their respective operations until the ring-shaped plate meets a certain smoothness.

9. The apparatus according to claim 8, wherein the smoothness adjusting mechanism comprises
a smoothness body which has a smoothness space formed on a top central part thereof and locates the ring-shaped plate in the smoothness space;
a smoothness supporter which has a flat surface, is located in a lateral wall of the smoothness space and contacts one surface of the ring-shaped plate;
a smoothness hitter which corresponds to the smoothness supporter, and contacts the other surface of the ring-shaped plate; and
a smoothness presser which is provided on the other surface of the smoothness space of the smoothness body, and moves the smoothness hitter toward the smoothness supporter,
wherein the smoothness presser adjusts the smoothness of the ring-shaped plate together with the smoothness supporter.

10. The apparatus according to claim 1, further comprising an edge bending mechanism which bends one end of the linear plate to bend the linear plate smoothly.

11. The apparatus according to claim 1, wherein before the linear plate is moved to the bending mechanism, the ends of the linear plate have central parts protruding to linearly contact each other after the bending operation.

12. The apparatus according to claim 1, wherein before the plate is moved to the bending mechanism, the ends of the plate are inclinedly formed to surface-contact each other after the bending operation, from a plane view.

13. A method for manufacturing a swing-ring plate comprising:
inserting a linear plate between a single fixing roller and a pair of elevating rollers which are provided below the fixing roller and are elevated toward a rotational center of the fixing roller by respective elevating cylinders;
bending the linear plate, inserted by the respective elevating rollers elevated by the respective elevating cylinders, in a ring shape, so that opposite ends of the linear plate face each other;
firstly fixing the plate in horizontal and vertical directions to locate both ends of the bent ring-shaped plate in one side;
pre-bonding a predetermined part of both ends of the fixed plate;
secondly fixing the plate, both ends of which are pre-bonded, by revolving the fixed pre-bonded plated with respect to a center thereof so that top and bottom surfaces of the pre-bonded plate are selectively positioned facing upward; and
rotating the plate fixed at the second fixing operation to sequentially locate the top surface or the bottom surface of the pre-bonded ends of the plate and completely bonding the pre-bonded ends of the plate.

14. The method according to claim 13, wherein the bending comprises
firstly bending the linear plate by pressing the linear plate, which is inserted by the elevation of the elevating rollers and one elevating cylinder positioned in a direction where the linear plate is inserted, toward the fixing roller; and
secondly bending the firstly-bent plate by the elevation of the elevating rollers and the other elevating cylinder, in which the firstly-bent plate is more pressed toward the fixing roller by the other elevating roller than the one elevating roller,
wherein the firstly bending and secondly bending are repeated until the ends of the linear plate contact each other and form a ring shape.

15. The method according to claim 13, wherein the firstly fixing comprises
stably seating the plate in a seating groove so that the ends of the ring-shaped plate are located between a pair of stoppers which have the seating grooves and are provided on a top surface of the base frame;
holding an upside of the ring-shaped plate stably seated in the stoppers and preventing the plate from being separated upward by a plurality of holders comprising rotating holding pieces;
horizontally fixing the plate by pressing the ring-shaped plate stably seated in the stoppers from the inside thereof toward the stoppers; and
vertically fixing the horizontally-fixed ring-shaped plate by pressing the plate from upside to down.

16. The method according to claim 13, wherein the secondly fixing comprises
supporting the pre-bonded plate by a second rotating frame provided in a center of a first rotating frame to rotate in the horizontal direction along the surface of the first rotating frame, wherein the first rotating frame is rotated with respect to a central axis by bearings provided on top surfaces of a pair of base frames spaced from each other at a consistent interval; and
fixing an upside of the plate by a plurality of fixing pieces respectively provided in the ends of the second rotating frame.

17. The method according to claim 13, wherein the completely bonding comprises
firstly rotating the plate by providing the first rotating frame being rotated with respect to a central axis by the bearings provided on the top surface of the pair of base frames spaced from each other at a consistent interval, supporting the pre-bonded plate by a second rotating frame provided in a center of a first rotating frame to rotate in the horizontal direction along the surface of the first rotating frame, and rotating the second rotating frame while an upside of the plate is fixed by a plurality of fixing pieces provided in the end of the second rotating frame to position the pre-bonded ends of the plate in a certain location;
firstly completely bonding the top surface of the pre-bonded ends of the plate located in the certain location;
secondly rotating the plate by rotating the first rotating frame to upwardly locate the bottom surface of the plate whose top surface is completely bonded, and rotating the second rotating frame to locate the bottom surface of the ends of the plate in a certain location; and
secondly completely bonding the bottom surface of the plate located in the certain location.

18. The method according to claim 13, wherein the pre-bonding and completely bonding comprises bonding the plate through one selected among gas welding, arc welding, resistance welding, laser welding and ultrasonic welding.

19. The method according to claim 13, further comprising between the bending and the firstly fixing, adjusting the smoothness of the bent ring-shaped plate; and
inspecting the smoothness of the ring-shaped plate, wherein the adjusting and inspecting are repeated until the ring-shaped plate meets a certain smoothness.
